(19) United States
(12) Patent Application Publication
(10) Pub. No.: US 2026/0030555 A1
(43) Pub. Date: Jan. 29, 2026

(54) METHODS, COMPUTER DEVICES, AND NON-TRANSITORY COMPUTER READABLE MEDIA FOR MANAGING MODELS AND DYNAMIC REPLACEMENT OF MULTIPLE MODELS

(71) Applicant: LINE Plus Corporation, Seongnam-si (KR)

(72) Inventor: Hyukjae JANG, Seongnam-si (KR)

(73) Assignee: LINE Plus Corporation, Seongnam-si (KR)

(21) Appl. No.: 19/342,910

(22) Filed: Sep. 29, 2025

Related U.S. Application Data
(63) Continuation of application No. PCT/KR2024/002385, filed on Feb. 23, 2024.

(30) Foreign Application Priority Data
Mar. 29, 2023 (KR) 10-2023-0041018

(51) Int. Cl. G06N 20/00

(52) U.S. Cl. CPC G06N 20/00

(57) ABSTRACT

Disclosed is a model management method executed by a computer device, the computer device including at least one processor configured to execute computer-readable instructions included in a memory, and the model management method including integrally managing, by the at least one processor, a plurality of Artificial Intelligence (AI) models through a platform of a client, each respective AI model among the plurality of AI models being related to a corresponding feature among a plurality of features included in an application installed at the client.

### CROSS-REFERENCE TO RELATED APPLICATIONS

This application is a continuation of International Patent Application No. PCT/KR2024/002385, filed on Feb. 23, 2024, which claims priority from Korean Patent Application No. 10-2023-0041018, filed on Mar. 29, 2023, the entire of contents of each of which are herein incorporated by reference.

### TECHNICAL FIELD

The following description relates to technology for managing an Artificial Intelligence (AI) model.

### RELATED ART

An Artificial Intelligence (AI) model, such as an AI model based on machine learning (may be referred to herein as a machine learning model), demonstrates the promising outcome in various computer vision technologies, such as object detection, image tagging, image classification, Optical Character Recognition (OCR), semantic segmentation, and video analysis.

Currently, the number of features using a machine learning model among features within a service provided from a user device is increasing.

### SUMMARY

Some example embodiments may provide a plurality of machine learning models used for various features within a client platform.

Some example embodiments may measure the performance of each model in a platform for a list of models used by a client.

Some example embodiments may dynamically replace a model used by the same feature (or a similar feature) depending on a service provision environment.

According to some example embodiments, there may be provided a model management method executed by a computer device, the computer device including at least one processor configured to execute computer-readable instructions included in a memory, and the model management method including integrally managing, by the at least one processor, a plurality of Artificial Intelligence (AI) models through a platform of a client, each respective AI model among the plurality of AI models being related to a corresponding feature among a plurality of features included in an application installed at the client.

According to some example embodiments, the integrally managing may include downloading or deleting a first model file based on an activation status of a first feature and a relationship between the first feature and a first AI model, the first model file corresponding to the first AI model, the first feature being among the plurality of features, and the first AI model being among the plurality of AI models.

According to some example embodiments, the integrally managing may include downloading at least one model file for each among the plurality of features based on device information corresponding to the computer device, the at least one model file corresponding to at least one AI model among the plurality of AI models, and the device information may include at least one of a device type, device specifications, a software platform, or country information.

According to some example embodiments, the model management method may further include measuring, by the at least one processor, a respective model performance in a client environment for each among the plurality of AI models through the platform.

According to some example embodiments, the measuring may include measuring result accuracy, memory usage, model file size, initialize latency, and inference latency for each among the plurality of AI models.

According to some example embodiments, the managing may include downloading at least one model file for each of the plurality of features based on performance measurement results for each of the plurality of AI models, the at least one model file corresponding to at least one AI model among the plurality of AI models.

According to some example embodiments, the model management method may further include dynamically providing, by the at least one processor, a first AI model among the plurality of AI models according to a client environment for a first feature among the plurality of features.

According to some example embodiments, the providing may include replacing a second AI model corresponding to the first feature based on a resource status of the computer device or a usage pattern of the first feature, the second AI model being among the plurality of AI models.

According to some example embodiments, the providing may include setting a schedule or a plan for two or more AI models corresponding to the first feature based on the client environment, the two or more AI models being among the plurality of AI models.

According to some example embodiments, the providing may include defining at least one profile among a use model, model scheduling, or model planning for each among a plurality of conditions for the client environment.

According to some example embodiments, the model management method may further include measuring, by the at least one processor, a respective model performance in the client environment for each among the plurality of AI models through the platform, and the defining may include determining the at least one profile based on performance measurement results for each of the plurality of AI models.

According to some example embodiments, there may be provided a non-transitory computer-readable recording medium storing a computer program that, when executed by a computer device, causes the computer device to perform the model management method.

According to some example embodiments, there may be provided a computer device including at least one processor configured to execute computer-readable instructions included in a memory, the at least one processor being configured to integrally manage a plurality of Artificial Intelligence (AI) models through a platform of a client, each respective AI model among the plurality of AI models related to a corresponding feature among a plurality of features included in an application installed at the client.

### BRIEF DESCRIPTION OF DRAWINGS

The various features and advantages of some example embodiments herein may become more apparent upon review of the detailed description in conjunction with the accompanying drawings. The accompanying drawings are merely provided for illustrative purposes and should not be interpreted to limit the scope of the claims.

FIG. 1 is a diagram illustrating an example of a network environment according to some example embodiments.

FIG. 2 is a block diagram illustrating an example of a computer device according to some example embodiments.

FIG. 3 illustrates an example of a machine learning model introduction process according to some example embodiments.

FIG. 4 illustrates an example of a relationship between a feature and a model according to some example embodiments.

FIG. 5 illustrates an example of a model supporting platform installed on a client side according to some example embodiments.

FIG. 6 is a flowchart illustrating an example of a method executable by a computer device according to some example embodiments.

FIG. 7 illustrates an example of a process of managing a machine learning model according to some example embodiments.

FIG. 8 illustrates an example of a process of measuring the performance of a machine learning model according to some example embodiments.

FIG. 9 illustrates an example of a process of dynamically replacing a machine learning model according to some example embodiments.

### DETAILED DESCRIPTION

Hereinafter, some example embodiments will be described in detail with reference to the accompanying drawings.

Some example embodiments relate to technology for managing an artificial intelligence (AI) model.

Some example embodiments including disclosures herein may provide a client side with a platform that serves to manage a plurality of machine learning models used for service provision, to automate the performance measurement of each model included in a list of models to be managed, and to dynamically provide a model of performance suitable for a service provision environment.

A model management system according to some example embodiments may be implemented by at least one computer device, and a model management method according to some example embodiments may be performed through the at least one computer device included in the model management system. Here, a computer program according to some example embodiments may be installed and executed on the computer device, and the computer device may perform the model management method according to some example embodiments under control of the executed computer program. The aforementioned computer program may be stored in a non-transitory computer-readable storage medium to computer-implement the model management method in conjunction with the computer device.

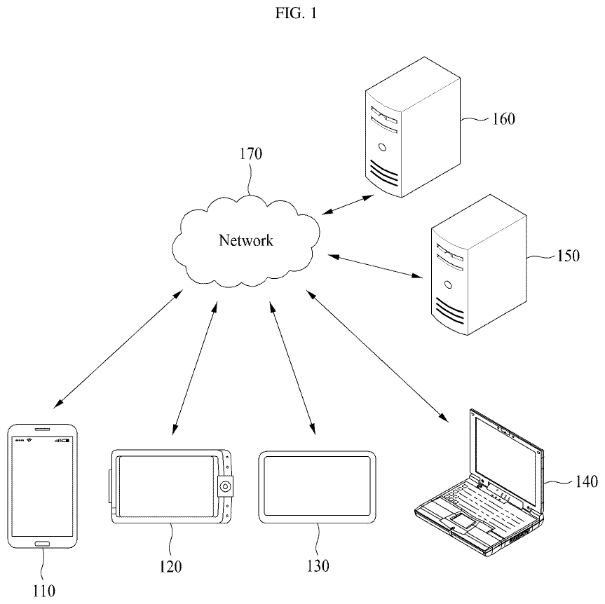

FIG. 1 illustrates an example of a network environment according to some example embodiments. Referring to FIG. 1, the network environment may include a plurality of electronic devices 110, 120, 130, and 140, a plurality of servers 150 and 160, and/or a network 170. FIG. 1 is provided as an example only. The number of electronic devices or the number of servers is not limited thereto. Also, the network environment of FIG. 1 is provided as an example only among environments applicable to some example embodiments, and the environment applicable to some example embodiments is not limited to the network environment of FIG. 1.

Each of the plurality of electronic devices 110, 120, 130, and 140 may be a fixed terminal or a mobile terminal that is configured as a computer device. For example, each of the plurality of electronic devices 110, 120, 130, and 140 may be a smartphone, a mobile phone, a navigation device, a computer, a laptop computer, a digital broadcasting terminal, a Personal Digital Assistant (PDA), a Portable Multimedia Player (PMP), a tablet Personal Computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, and 140 and/or the servers 150 and 160 over the network 170 in a wireless and/or wired communication manner.

The communication scheme is not limited and may include a near field wireless communication scheme between devices as well as a communication scheme using a communication network (e.g., mobile communication network, wired Internet, wireless Internet, broadcasting network, etc.) includable in the network 170. For example, the network 170 may include at least one network among networks that include a Personal Area Network (PAN), a Local Area Network (LAN), a Campus Area Network (CAN), a Metropolitan Area Network (MAN), a Wide Area Network (WAN), a Broadband Network (BBN), the Internet, etc. Also, the network 170 may include at least one of network topologies that include a bus network, a star network, a ring network, a mesh network, a star-bus network, a tree or hierarchical network, and the like. However, these are provided as examples only.

According to some example embodiments, operations described herein as being performed by each of the plurality of electronic devices 110, 120, 130, and 140, and/or each of the plurality of servers 150 and 160 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a Central Processing Unit (CPU), an Arithmetic Logic Unit (ALU), a Graphics Processing Unit (GPU), a digital signal processor, a microcomputer, a Field Programmable Gate Array (FPGA), a System-on-Chip (SoC), a programmable logic unit, a microprocessor, Application-Specific Integrated Circuit (ASIC), etc.

For example, each of the servers 150 and 160 may be implemented as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., messenger service, integrated search service, content recommendation service) to the plurality of electronic devices 110, 120, 130, and 140 connected through the network 170.

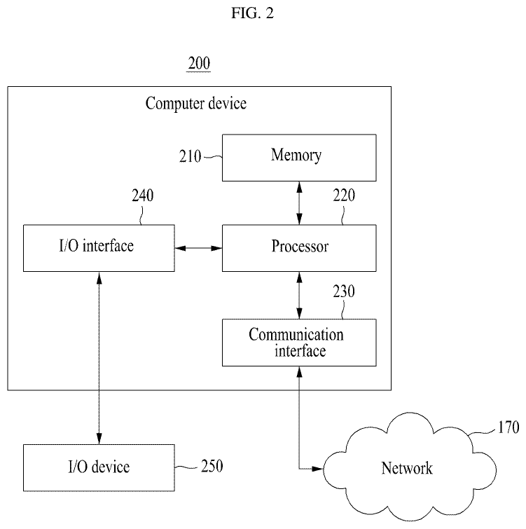

FIG. 2 is a block diagram illustrating an example of a computer device according to some example embodiments. Each of the plurality of electronic devices 110, 120, 130, and 140, and/or each of the servers 150 and 160 described above may be implemented by a computer device 200 of FIG. 2.

Referring to FIG. 2, the computer device 200 may include a memory 210, a processor 220, a communication interface 230, and/or an Input/Output (I/O) interface 240. The memory 210 may include a permanent mass storage device, such as a Random Access Memory (RAM), a Read Only Memory (ROM), a disk drive, etc., as a non-transitory computer-readable recording medium. The permanent mass storage device, such as ROM and a disk drive, may be included in the computer device 200 as a permanent storage device separate from the memory 210. Also, an Operating System (OS) and at least one program code may be stored in the memory 210. Such software components may be loaded to the memory 210 from another non-transitory computer-readable recording medium separate from the memory 210. The other non-transitory computer-readable recording medium may include, for example, a floppy drive, a disk, a tape, a DVD/CD-ROM drive, a memory card, etc. In some example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and/or I/O operations. The instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the computer device 200 and another apparatus (e.g., the aforementioned storage devices) over the network 170. For example, the processor 220 of the computer device 200 may deliver a request or an instruction created based on a program code stored in the storage device such as the memory 210, data, and/or a file, to other apparatuses over the network 170 under control of the communication interface 230. Inversely, a signal, an instruction, data, a file, etc., from another apparatus may be received at the computer device 200 through the network 170 and the communication interface 230 of the computer device 200. A signal, an instruction, data, etc., received through the communication interface 230 may be delivered to the processor 220 or the memory 210, and a file, etc., may be stored in a storage medium (e.g., the permanent storage device) further includable in the computer device 200.

The I/O interface 240 may be a device used for interfacing with an I/O device 250. The I/O device 250 may include an input device and/or an output device. For example, the input device may include a device, such as a microphone, a keyboard, a mouse, etc., and the output device may include a device, such as a display, a speaker, etc. As another example, the I/O interface 240 may be a device for interfacing with an apparatus in which an input function and an output function are integrated into a single function, such as a touchscreen.

The I/O device 250 may be configured as a single apparatus with the computer device 200. According to some example embodiments, operations described herein as being performed by the computer device 200, the processor 220, the communication interface 230, and/or the I/O interface 240 may be performed by processing circuitry.

Also, in some example embodiments, the computer device 200 may include the number of components greater than or less than the number of components shown in FIG. 2. However, there is no need to clearly illustrate many conventional components. For example, the computer device 200 may include at least a portion of the I/O device 250, or may further include other components, for example, a transceiver, a database, etc.

Hereinafter, detailed examples of a method and device for managing a model, and for dynamic replacement of multiple models, are described.

In some example embodiments, a platform that serves to manage and provide a plurality of machine learning models may be installed on a client side.

A client used herein may refer to an electronic device that is implemented as the computer device 200, and may represent a device corresponding to a user-side terminal, such as a mobile device or a Personal Computer (PC) on which an application is installed.

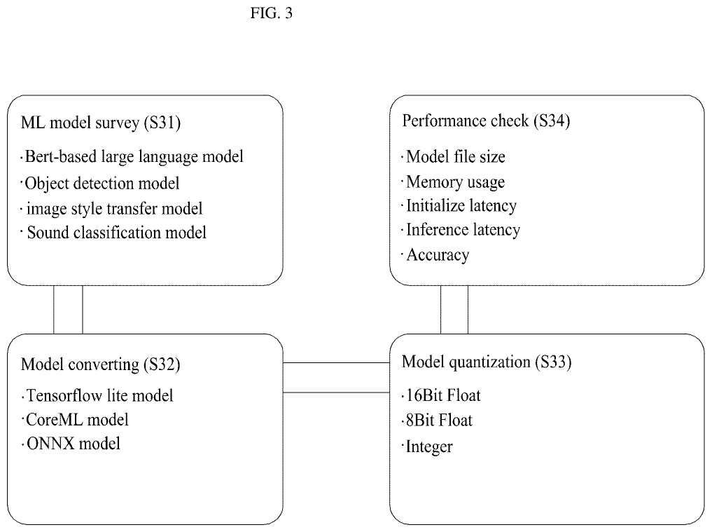

Referring to FIG. 3, to use a machine learning model in a user device, a process of surveying an available model for a desired feature (model survey) (S31), a process of converting the model to be suitable for a platform on a device (model converting) (S32), a process of making the model lightweight (model quantization) (S33), and/or a process of verifying a model performance in a service environment (performance check) (S34) may be performed. FIG. 3 illustrates a process of introducing a machine learning model to a client-side platform. For the model survey stage, a specific example could be a mobile camera app adding a ‘real-time object recognition’ feature. In this case, various object recognition models, such as the ‘YOLO (You Only Look Once)’ family or ‘SSD (Single Shot MultiBox Detector)’ models, could be surveyed to select the most suitable model based on the mobile device's specifications and service requirements (e.g., recognition accuracy, speed). For the model converting stage, a PyTorch or TensorFlow-based model trained on a server can be converted into a TensorFlow Lite or ONNX (Open Neural Network Exchange) format for efficient operation on the client device, ensuring compatibility with various mobile operating systems (e.g., Android, IOS). For the model quantization stage, if an image classification model's size is too large (e.g., 500 MB), its parameters can be quantized from 32-bit floating-point (float) to 8-bit integer (int) to reduce the model size to, for example, 125 MB, which reduces the load on the mobile device.

Currently, a feature of using a machine learning model is increasing among features within a service provided from a device. A single feature may utilize a single model, and a plurality of features may use a single model or a single feature may use a plurality of models.

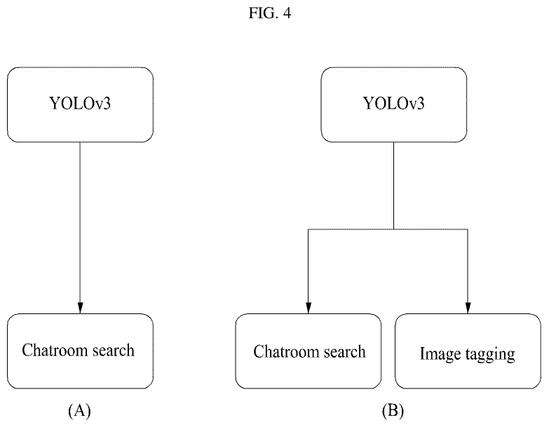

Referring to FIG. 4, in the case of 1:1 in which a single feature uses a single model, for example, in a case in which a chatroom search feature uses YOLOv3 ((A) of FIG. 4), a model file of YOLOv3 may be downloaded if the chatroom search feature is activated (on) in labs or a configuration environment within a messenger service. If the chatroom search feature is deactivated (off), the corresponding model file is deleted.

However, when the chatroom search feature and an image tagging feature among features of the messenger service commonly use YOLOv3 ((B) of FIG. 4), a model file of YOLOv3 may not be deleted due to the image tagging feature although a chatroom search feature is deactivated.

In this way, when the relationship between the feature and the machine learning model becomes complex such as 1:N, N:1, and N:N, it is difficult to manage a model in each feature.

Even for the same machine learning model (or similar machine learning models), there are various variation models. For example, in the case of a you only look once (YOLO) model for object detection within an image, dozens of variation models are present, such as YOLOv3, YOLOv4, YOLOv5, YOLOv3FP16, and YOLOv3Int8LUT.

Since each model has a different input image condition, memory usage, processing speed, accuracy, etc., it is necessary (or otherwise, desirable) to select a machine learning model that suits a desired feature and a device environment condition.

Performance measurement of the machine learning model is performed by focusing on accuracy based on a pre-collected (or collected) dataset under a given environment. Accuracy requirements (or specifications) that dynamically change in an actual service environment, processing speed that also dynamically changes depending on a device and an execution environment, or message usage is not considered. After conducting a test based on some of sampled models, services are provided by installing a most appropriate model based on test results.

In some example embodiments, a platform (hereinafter, referred to as “model support platform”) that serves to manage a plurality of machine learning models, to automate the performance measurement of each model included in a list of models to be managed, and to dynamically replace a model depending on a service provision environment may be installed on a client side.

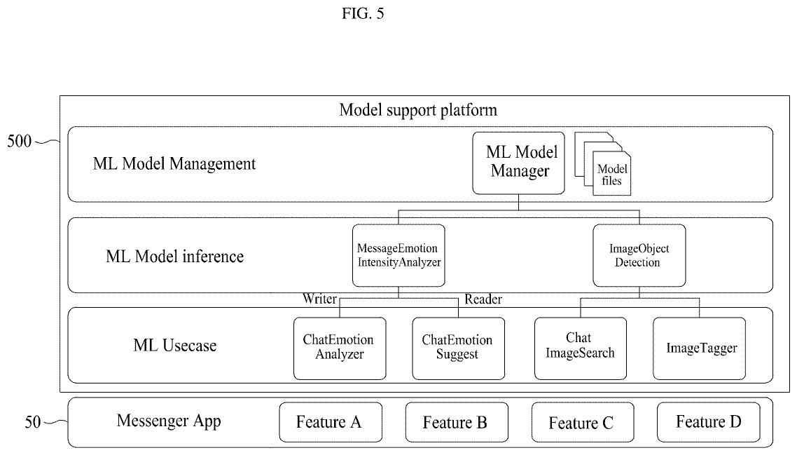

For example, referring to FIG. 5, the computer device 200 according to some example embodiments may configure, as a client-side platform, a model support platform 500 for managing a plurality of machine learning models used by features within a messenger service with respect to a messenger application 50 installed on a client. For example, among features provided by the messenger service, the model support platform 500 may provide a machine learning model for message sentiment intensity analysis for features related to chat sentiment analysis, chat reaction suggestion, etc., and may provide a machine learning model for image object recognition for features related to chat image search, image tagging, etc. According to some example embodiments, operations described herein as being performed by the model support platform 500 and/or the messenger application 50 may be performed by processing circuitry. FIG. 5 shows an example of a platform installed on the client side that manages and supports models. As an example of a scenario where a model is replaced based on device resources like memory, battery, and CPU usage, if a smartphone's augmented reality (AR) filter app is running and the battery level drops below 20% or another high-spec game runs in the background, the platform can replace the existing high-quality AR model (e.g., 100 MB) with a lightweight AR model (e.g., 30 MB) that consumes fewer resources, thereby maintaining the app's stable operation.

The processor 220 of the computer device 200 may be implemented as a component for performing the following model management method. Depending on some example embodiments, the components of the processor 220 may be selectively included in or excluded from the processor 220. Also, depending on some example embodiments, the components of the processor 220 may be separated or merged for functional representation of the processor 220.

The processor 220 and the components of the processor 220 may control the computer device 200 to perform operations included in the following model management method. For example, the processor 220 and the components of the processor 220 may be implemented to execute an instruction according to a code of at least one program and a code of an operating system (OS) included in the memory 210.

Here, the components of the processor 220 may be representations of different functions performed by the processor 220 in response to an instruction provided from a program code stored in the computer device 200.

The processor 220 may read a necessary (or otherwise, used) instruction from the memory 210 to which instructions related to control of the computer device 200 are loaded. In this case, the read instruction may include an instruction for the processor 220 to control operations described below to be performed.

The operations included in the model management method described below may be performed in order different from the illustrated order and some of the operations may be omitted or an additional process may be further included.

The operations included in the model management method may be performed by a client. Depending on some example embodiments, at least some of the operations may be performed by the server 150.

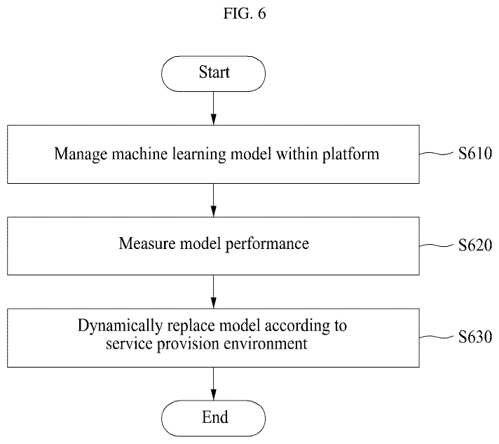

FIG. 6 is a flowchart illustrating an example of a method executable by a computer device according to some example embodiments.

Referring to FIG. 6, in operation S610, the processor 220 may manage a machine learning model (may also be referred to as a model herein) used by a corresponding feature within the model support platform 500 for the feature that a client desires to provide. The processor 220 may download or delete a corresponding model depending on whether features included in a service application on the client use the model within a platform installed on the client. According to some example embodiments, the processor 220 may download the corresponding model from a server (e.g., the server 150 and/or the server 160). According to some example embodiments, references herein to downloading and/or deleting a model may refer to downloading or deleting a model file corresponding to the model. In the case of a model used by an activated feature among the features included in the application, a corresponding model file may be downloaded. In the case of a model used by a deactivated feature, a corresponding model file may be deleted. Here, the processor 220 may determine and download an optimal (or desirable) model used by each feature based on user device information. Even for the same machine learning model (or similar machine learning models), there are different variations of models. Rather than providing a common model to all clients for a specific feature, different models may be provided (e.g., selected, applied, output, etc.) depending a client environment. User device information may include a device type, device specifications, software platform (e.g., Android, IOS, etc.), and/or country information (language information), which indicate a service provision environment, and the model support platform 500 may download and manage a model appropriate for user device information for each feature. Even in a complex usage environment in which features and models are connected based on 1:1, 1:N, N:1, or N:N, multi-model management may be easily performed through the model support platform 500. The processor 220 may integrally manage models used by the respective features based on a relationship between features and models with respect to all features provided by a client application through the model support platform 500.

In some example embodiments, the processing circuitry may perform some operations (e.g., the operations described herein as being performed by the machine learning models) by artificial intelligence and/or machine learning. As an example, the processing circuitry may implement an artificial neural network that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as Convolutional Neural Networks (CNN), Recurrent Neural Networks (RNN) optionally including Long Short-Term Memory (LSTM) units and/or Gated Recurrent Units (GRU), Sacking-based Deep Neural Networks (S-DNN), State-Space Dynamic Neural Networks (S-SDNN), deconvolution networks, Deep Belief Networks (DBN), and/or Restricted Boltzmann Machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, the machine learning model may have any structure that is trainable, e.g., with training data. For example, the machine learning model may include an artificial neural network, a decision tree, a support vector machine, a Bayesian network, a genetic algorithm, and/or the like. The machine learning model will now be described by mainly referring to an artificial neural network, but some example embodiments are not limited thereto. Non-limiting examples of the artificial neural network may include a Convolution Neural Network (CNN), a Region based Convolution Neural Network (R-CNN), a Region Proposal Network (RPN), a Recurrent Neural Network (RNN), a Stacking-based Deep Neural Network (S-DNN), a State-Space Dynamic Neural Network (S-SDNN), a deconvolution network, a Deep Belief Network (DBN), a Restricted Boltzmann Machine (RBM), a fully convolutional network, a Long Short-Term Memory (LSTM) network, a classification network, and/or the like.

In operation S620, the processor 220 may measure model performance within the model support platform 500 for a machine learning model available to the client. When a plurality of models are available for the same feature (or similar features), the processor 220 may perform performance measurement in terms of a service aspect. A list of models may be provided to the model support platform 500, and the model support platform 500 may measure the model performance through testing for each model included in the list of models. For example, the model support platform 500 may measure performance items from the service standpoint by downloading machine learning models for recommendation one by one from the server 150 without changing a feature code for a sticker recommendation feature that is a feature within the messenger. The performance items may include not only result accuracy, but also memory usage (or CPU usage), a model file size (or storage usage), an initial model loading speed (initialize latency), and/or a result processing speed (inference latency). The performance metrics of machine learning models are not linearly determined based on general performance criteria, such as CPU clock speed and RAM capacity. For example, the processing speed of a machine learning model is complexly determined based on different variables, such as internal structure, computational acceleration using a GPU or Tensor Processing Unit (TPU), a CPU type such as ARM series or x86 series, and the number of threads used for processing. Therefore, simply having a fast CPU clock does not necessarily indicate a faster processing speed, and the model performance may vary depending on device specifications or usage environment for each device. For each feature included in the application, model performance measurement may be automated within the model support platform 500, and model performance measurement results may be used in a model management feature (S610). For example, a model with the best performance through testing may be downloaded among a plurality of models available for the sticker recommendation feature.

In operation S630, the processor 220 may dynamically replace a machine learning model depending on a service provision environment at the client. That is, the processor 220 may provide a corresponding service by selecting and controlling various versions (variations of models) of the machine learning model of the same feature (or a similar feature) according to the service provision environment. For example, the processor 220 may replace a model used for each feature based on a resource status of the user device (e.g., CPU, memory, storage space, etc.). For example, when the user device is low on memory and has sufficient storage space, a model with lower memory usage may be used based on the memory status. As another example, the processor 220 may replace a model used for a corresponding feature in consideration of a usage pattern for the feature. For example, in the case of a feature repeatedly and frequently used by the user, faster processing results may be provided using a model with lower memory usage. Also, when the user occasionally uses a feature with large input data, a model with high accuracy may be used regardless of large resource consumption. As another example, the processor 220 may perform scheduling or planning of a model by considering the model use status of a feature. In the case of a feature that complexly uses a plurality of models, a model appropriate for a complex situation used with other models may be employed. Here, it is possible to set scheduling for each model or to provide planning for the overall time limit of the corresponding feature. For example, in the case of a feature that uses models in a chain, it is possible to set scheduling or planning with the shortest overall processing speed for faster inference. According to some example embodiments, when multiple AI models are used for a single feature, a schedule or plan for their execution order and timing can be set. For example, a ‘real-time background blur’ feature in a camera app can use two AI models: Model 1 to recognize the human form and separate the foreground and background, and Model 2 to apply a blur effect to the separated background area. The schedule for this feature would be ‘Model 1→Model 2’. This can be dynamically optimized based on the client environment (e.g., device performance). For example, on a high-spec device, a plan can be set to run both models simultaneously (parallel processing) to increase speed. Also, if two or more inferences may not be performed simultaneously (or contemporaneously) due to resources of the user device, an appropriate time may be allocated for each model, or a model of a version appropriate for the corresponding resource status may be used. Also, when a specific device has lower CPU performance but is equipped with higher-performance TPU, the fast processing results may be provided through replacement with a model optimized (or configured) for the corresponding TPU operation. Some example embodiments may include selecting and using a machine learning model with performance optimized (or desirable) for a service provision environment as a model used for each feature by comprehensively considering the performance of machine learning models. According to some example embodiments, for resource-based provision, if the battery level is below 20%, a lightweight model with low power consumption can be provided instead of a high-performance model. For usage pattern-based provision, if a user has not used the voice assistant feature for more than 3 months, the corresponding model can be deleted or unnecessary model files can be pruned to leave only minimal functionality.

According to some example embodiments, the processor 220 may use the machine learning model to perform an operation related to the feature to which the machine learning model corresponds. For example, the processor 220 may apply the machine learning model to (e.g., input into the machine learning model) textual data (e.g., a chat dialog from a chatroom environment), voice data (e.g., a voice call) and/or image data (e.g., still or moving images, such as a video call) in order to obtain an output from the machine learning model corresponding to the feature. The feature may include performing a search, object recognition, a sentiment intensity analysis, language translation, etc., and the output may include a search result, a tagged image, an analysis result, a translated text, etc., respectively.

According to some example embodiments, the output from the machine learning model may be used by the processor 220 to generate an image for display (e.g., on the I/O device 250). For example, the output from the machine learning model may be used to determine specific pixels of the image to be annotated with corresponding tags, and/or specific pixels at which text of the search result, analysis result, translated text, etc., will be displayed.

According to some example embodiments, the output from the machine learning model may be transmitted (e.g., under the control of the processor 220) to another device (e.g., the server 150 and/or 160 for communication to devices of other chat participants). For example, the processor 220 may generate a first signal, process the first signal to perform one or more among modulating, upconverting, filtering, amplifying and/or encrypting on the first signal (e.g., using the communication interface 230), and transmit the processed first signal to the network 170 via one or more antennas of the computer device 200. Additionally or alternatively, the processor 220 may receive a second signal from the network 170 via the one or more antennas of the computer device 200, process the second signal to perform one or more among demodulating, downconverting, filtering, amplifying and/or decrypting on the second signal (e.g., by the communication interface 230), and perform a further operation(s) based on the processed second signal. For example, the further operation(s) may include one or more of providing the processed second signal to a corresponding application executing on the processor 220, storing the processed second signal (e.g., in the memory 210), sending a response signal to the network 170 (e.g., based on a processing result of the corresponding application executing on the processor 220), etc.

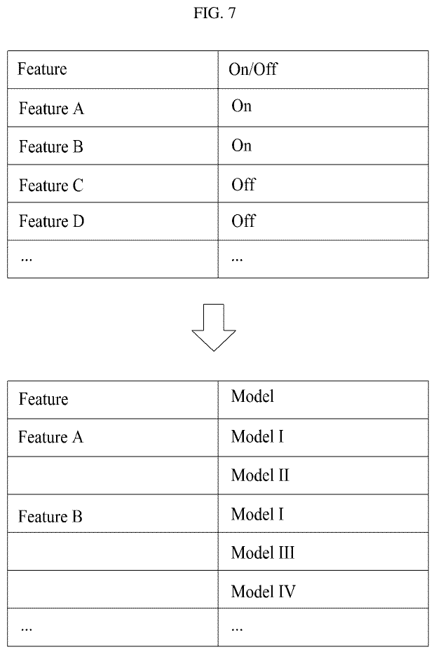

FIG. 7 illustrates an example of a process of managing a machine learning model according to some example embodiments.

The processor 220 may manage a machine learning model for each feature of an application within the model support platform 500.

Referring to FIG. 7, when feature A and feature B are activated among features included in the application, the model support platform 500 may download and manage models used by the activated features A and B from the server 150. For example, the model support platform 500 may download model I and model II as models used by feature A and may manage model I, model III, and model IV as models used by feature B. According to some example embodiments, examples of features include real-time object detection, which recognizes and displays the location of objects in a camera app; a voice assistant, which converts voice commands to text and performs actions based on user intent; and image classification, which analyzes an image and classifies it into a predefined category. For the real-time object detection feature, a YOLO model can be applied. YOLO uses a single neural network to classify and locate objects in an image, achieving very high speed by simultaneously predicting bounding boxes and class probabilities with a single forward pass. The YOLO model can be trained using a large-scale image dataset such as COCO (Common Objects in Context), and during inference, it takes real-time image data from the user's camera as input and provides an output that includes the predicted object's class, confidence score, and location.

Then, when feature A is deactivated, the models used by feature A may be deleted. Here, model I that is also used by feature B is not deleted, and only model II used by feature A is deleted. The model support platform 500 may integrally manage all models used by the client based on an activation status of each feature provided from the application and relationship between features and models.

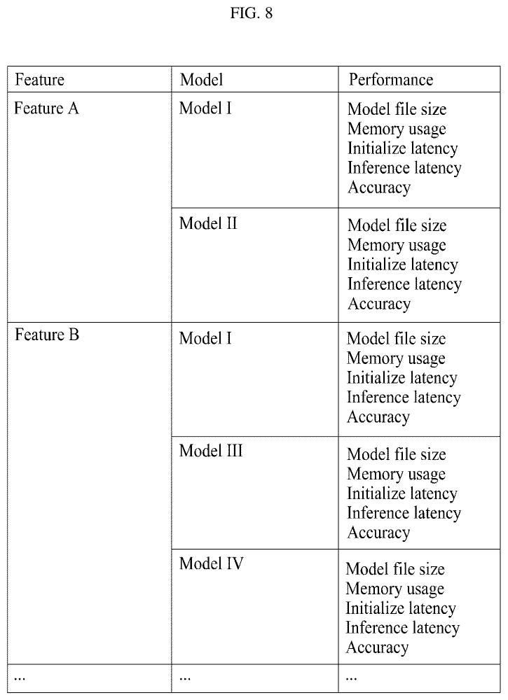

FIG. 8 illustrates an example of a process of measuring the performance of a machine learning model according to some example embodiments.

The processor 220 may automate the performance measurement of each model included in a list of models to be managed within the model support platform 500.

Referring to FIG. 8, the model support platform 500 may measure the actual performance in a client environment through testing for each of model I, model II, model III, and model IV used by feature A and feature B. The model support platform 500 may measure result accuracy, memory usage, model file size, initial model loading speed (initialize latency), and/or result processing speed (inference latency) as model performance metrics. According to some example embodiments, for accuracy, taking a voice recognition model as an example, the system measures the misrecognition rate when a user's voice command like ‘What's the weather today?’ is converted to text. If Model A has a 1% misrecognition rate and Model B has a 5% rate, Model A is evaluated as more accurate. For memory usage, the system measures the amount of RAM used during model loading and inference for an image classification model. If Model A uses 500 MB and Model B uses 200 MB, Model B is evaluated as the more lightweight model. For processing speed, the system measures how many frames per second (FPS) a real-time object detection model can process. If Model A processes 30 FPS and Model B processes 15 FPS, Model A is evaluated as faster.

The model support platform 500 may perform the performance measurement for a variation model available for the same feature (or a similar feature) during a model management process and may also download a model based on performance measurement results. For example, when a specific model used by feature A has ten versions of variation models, the performance may be measured through testing in the client environment for each version of the entire variation model pool and then a variation model of a version with the best performance may be selected as the model for feature A in the client.

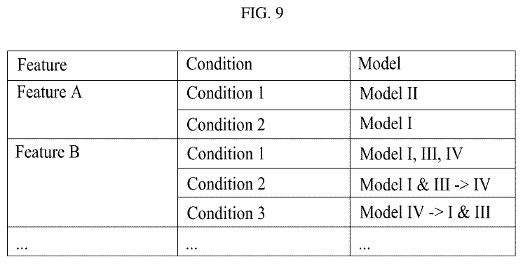

FIG. 9 illustrates an example of a process of dynamically replacing a machine learning model according to some example embodiments.

The processor 220 may change a machine learning model depending on a service provision environment in a client within the model support platform 500.

Referring to FIG. 9, it is assumed that either model I or model II is selectively used to provide feature A. Here, the model support platform 500 may use model II when the service provision environment in the client for feature A satisfies a first condition, and may use model I when the service provision environment satisfies a second condition. That is, in a situation of the first condition in which model I and model II are downloaded to provide feature A, model II is used, and in a situation of the second condition, model I is used. For example, when the original text that is input in a translation feature is short text with less than a predetermined (or alternatively, given) length, model II is used, and when the original text is long text with the predetermined (or alternatively, given) length or more, model I is used. Also, when language of an input message in the sticker recommendation feature within the messenger is English, model II for English-based sticker recommendation is used, and when the language of the input message is Hangul, model I for Hangul-based sticker recommendation is used.

It is assumed that model I, model III, and model IV are used in combination to provide feature B. For example, a search feature within the messenger uses model I for text search, model III for voice search, and model IV for image search with the search scope including not only text included in a chatroom but also voice files and/or image files. Here, when the service provision environment on the client satisfies the first condition for the search feature, the model support platform 500 may simultaneously (or contemporaneously) perform text search, voice search, and image search using model I, model III, and model IV. In the service provision environment of the second condition, text search and voice search are initially performed according to scheduling by model (model I&III) and then image search may be performed (model IV). In the service provision environment of the third condition, image search may be performed according to scheduling by model (model IV) and then, text search and voice search may be performed (model I&III).

Depending on some example embodiments, the processing time for feature B may be limited and the processing time for each model may be differently set depending on the service provision environment of the client. For example, the processing time of model I, model III, and model IV may be distributed based on 1:1:1 in the service provision environment of the first condition environment, 3:3:4 in the service provision environment of the second condition, and 2:2:6 in the service provision environment of the third condition.

Conditions for the service provision environment of the user device (e.g., client) and profiles such as a use model (e.g., a use model profile), a model scheduling rule (e.g., a model scheduling rule profile), and/or a model planning rule (e.g., a model planning rule profile) for each condition may be defined in advance. In the model support platform 500, the actual performance in the service provision environment may be measured for each machine learning model, and the model performance measurement results may be utilized as basic data for defining conditions for the service provision environment and a model profile for each condition. That is, the model support platform 500 may measure performance measurement results for each model for a list of all models used in the client and may determine a profile, such as a use model, a model scheduling rule, and/or a model planning rule for each condition with respect to the service provision environment using the performance measurement results for each model, in order to dynamically replace a model according to the service provision environment. According to some example embodiments, a profile can be defined to pre-configure model usage, scheduling, or planning based on various client environments. For a device spec profile, a ‘High-Quality Model Profile’ can be applied to high-spec devices (e.g., RAM 8 GB or more) to use high-performance, large-capacity models for image/video processing features. A ‘Lightweight Model Profile’ can be applied to low-spec devices (e.g., RAM less than 4 GB) to use low-capacity, low-power models. For a country-specific profile, a ‘Korean Profile’ can be set to primarily use a Korean language model for voice recognition and provide Korean-English and Korean-Chinese models for translation features. A ‘U.S. Profile’ can be set to primarily use an English model for voice recognition and provide English-Spanish and English-Chinese models for translation features.

According to some example embodiments, it is possible to manage a plurality of machine learning models used by a plurality of features within a client platform, to measure the performance of each model within the platform for a list of models used by the client, and to dynamically replace a model used by the same feature (or a similar feature) depending on a service provision environment.

Existing devices and methods for providing services related to application features involve using machine learning models to provide services for each of the application features. However, as a number of the features in the application increases the resource consumption (e.g., memory, processor, power, delay, etc.) of the existing devices likewise increases.

However, according to some example embodiments, improved devices and methods are provided for facilitating application features. For example, the improved devices and methods involve downloading and/or deleting machine learning models according to whether corresponding features are activated or deactivated. Also, the improved devices and methods involve selecting specific machine learning models for download and/or deletion based on environment conditions of a device on which the application executes. Accordingly, the improved devices and methods overcome the deficiencies of the conventional devices and methods to at least reduce resource consumption (e.g., memory, processor, power, delay, etc.).

The apparatuses described herein may be implemented using hardware components, software components, and/or combination of the hardware components and the software components. For example, the apparatuses and the components described herein may be implemented using one or more general-purpose or special purpose computers, such as, for example, a processor, a controller, an Arithmetic Logic Unit (ALU), a digital signal processor, a microcomputer, a Field Programmable Gate Array (FPGA), a Programmable Logic Unit (PLU), a microprocessor, or any other device capable of responding to and executing instructions in a defined manner. The processing device may run an Operating System (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, non-transitory computer storage medium or device, to be interpreted by the processing device or to provide an instruction or data to the processing device. The software also may be distributed over network coupled computer systems so that the software is stored and executed in a distributed fashion. The software and data may be stored by one or more non-transitory computer readable storage media.

The methods according to the above-described examples may be configured in a form of program instructions performed through various computer devices and recorded in non-transitory computer-readable media. Here, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store program instructions, such as Read-Only Memory (ROM), Random Access Memory (RAM), flash memory, and the like. Also, examples of other media may include recording media and storage media managed by an app store that distributes applications or a site that supplies and distributes other various types of software, a server, and the like.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although some example embodiments are described with reference to some specific examples and accompanying drawings, it will be apparent to one of ordinary skill in the art that various alterations and modifications in form and details may be made in these examples without departing from the spirit and scope of the claims and their equivalents. For example, suitable results may be achieved if the described techniques are performed in different order, and/or if components in a described system, architecture, device, or circuit are combined in a different manner, or replaced or supplemented by other components or their equivalents.

Therefore, other implementations, other examples, and equivalents of the claims are to be construed as being included in the claims.

What is claimed is:

1. A model management method executed by a computer device, the computer device including at least one processor configured to execute computer-readable instructions included in a memory, and the model management method comprising:
integrally managing, by the at least one processor, a plurality of Artificial Intelligence (AI) models through a platform of a client, each respective AI model among the plurality of AI models being related to a corresponding feature among a plurality of features included in an application installed at the client.

2. The model management method of claim 1, wherein the integrally managing includes downloading or deleting a first model file based on an activation status of a first feature and a relationship between the first feature and a first AI model, the first model file corresponding to the first AI model, the first feature being among the plurality of features, and the first AI model being among the plurality of AI models.

3. The model management method of claim 1, wherein
the integrally managing includes downloading at least one model file for each among the plurality of features based on device information corresponding to the computer device, the at least one model file corresponding to at least one AI model among the plurality of AI models; and
the device information includes at least one of a device type, device specifications, a software platform, or country information.

4. The model management method of claim 1, further comprising:
measuring, by the at least one processor, a respective model performance in a client environment for each among the plurality of AI models through the platform.

5. The model management method of claim 4, wherein the measuring includes measuring result accuracy, memory usage, model file size, initialize latency, and inference latency for each among the plurality of AI models.

6. The model management method of claim 4, wherein the managing includes downloading at least one model file for each of the plurality of features based on performance measurement results for each of the plurality of AI models, the at least one model file corresponding to at least one AI model among the plurality of AI models.

7. The model management method of claim 1, further comprising:
dynamically providing, by the at least one processor, a first AI model among the plurality of AI models according to a client environment for a first feature among the plurality of features.

8. The model management method of claim 7, wherein the providing includes replacing a second AI model corresponding to the first feature based on a resource status of the computer device or a usage pattern of the first feature, the second AI model being among the plurality of AI models.

9. The model management method of claim 7, wherein the providing includes setting a schedule or a plan for two or more AI models corresponding to the first feature based on the client environment, the two or more AI models being among the plurality of AI models.

10. The model management method of claim 7, wherein the providing includes defining at least one profile among a use model, model scheduling, or model planning for each among a plurality of conditions for the client environment.

11. The model management method of claim 10, wherein
the model management method further comprises measuring, by the at least one processor, a respective model performance in the client environment for each among the plurality of AI models through the platform; and
the defining includes determining the at least one profile based on performance measurement results for each of the plurality of AI models.

12. A non-transitory computer-readable recording medium storing a computer program that, when executed by a computer device, causes the computer device to perform the model management method of claim 1.

13. A computer device comprising:
at least one processor configured to execute computer-readable instructions included in a memory, the at least one processor being configured to integrally manage a plurality of Artificial Intelligence (AI) models through a platform of a client, each respective AI model among the plurality of AI models related to a corresponding feature among a plurality of features included in an application installed at the client.

14. The computer device of claim 13, wherein the at least one processor is configured to download or delete a first model file based on an activation status of a first feature and a relationship between the first feature and a first AI model, the first model file corresponding to the first AI model, the first feature being among the plurality of features, and the first AI model being among the plurality of AI models.

15. The computer device of claim 13, wherein
the at least one processor is configured to download at least one model file for each among the plurality of features based on device information corresponding to the computer device, the at least one model file corresponding to at least one AI model among the plurality of AI models; and
the device information includes at least one of a device type, device specifications, a software platform, or country information.

16. The computer device of claim 13, wherein the at least one processor is configured to:
measure a respective model performance in a client environment for each among the plurality of AI models through the platform; and
measure the respective model performance including measuring result accuracy, memory usage, model file size, initialize latency, and inference latency for each among the plurality of AI models.

17. The computer device of claim 16, wherein the at least one processor is configured to download at least one model file for each of the plurality of features based on performance measurement results for each of the plurality of AI models, the at least one model file corresponding to at least one AI model among the plurality of AI models.

18. The computer device of claim 13, wherein the at least one processor is configured to dynamically provide a first AI model among the plurality of AI models according to a client environment for a first feature among the plurality of features.

19. The computer device of claim 18, wherein the at least one processor is configured to replace a second AI model corresponding to the first feature based on a resource status of the computer device or a usage pattern of the first feature, the second AI model being among the plurality of AI models.

20. The computer device of claim 18, wherein the at least one processor is configured to set scheduling or planning for two or more AI models corresponding to the first feature based on the client environment, the two or more AI models being among the plurality of AI models.
